(19) United States
(12) Patent Application Publication
(10) Pub. No.: US 2007/0033042 A1
(43) Pub. Date: Feb. 8, 2007

(54) Speech detection fusing multi-class acoustic-phonetic, and energy features

(75) Inventors: Etienne Marcheret, White Plains, NY (US); Karthik Visweswariah, Briarcliff Manor, NY (US)

Correspondence Address: DUKE. W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/196,698

(22) Filed: Aug. 3, 2005

(51) Int. Cl. G10L 15/00

(52) U.S. Cl. 704/255; 704/215

(57) ABSTRACT

A speech detection system extracts a plurality of features from multiple input streams. In the acoustic model space, the tree of Gaussians in the model is pruned to include the active states. The Gaussians are mapped to Hidden Markov Model states for Viterbi phoneme alignment. Another feature space, such as the energy feature space is combined with the acoustic feature space. In the feature space, the features are combined and principal component analysis decorrelates the features to fewer dimensions, thus reducing the number of features. The Gaussians are also mapped to silence, disfluent phoneme, or voiced phoneme classes. The silence class is true silence and the voiced phoneme class is speech. The disfluent class may be speech or non-speech. If a frame is classified as disfluent, then that frame is re-classified as the silence class or the voiced phoneme class based on adjacent frames.

### BACKGROUND OF THE INVENTION

1. Field of the Invention

The present invention relates to speech detection and, in particular, to speech detection in a data processing system. Still more particularly, the present invention provides a method, apparatus, and program for speech detection using multiple feature spaces.

2. Description of the Related Art

An important feature of audio processing is detecting speech in the presence of background noise. This problem, often called speech detection, concerns detecting the beginning and ending of a section of speech. These segments of speech may then be isolated for transmission over a network, storage, speech recognition, etc. By removing silent periods between segments of speech, network bandwidth or processing resources can be used more efficiently

Proper estimation of the start and end of a speech segment eliminates unnecessary processing for automated speech recognition on preceding or ensuing silence, which leads to an efficient computation and, more importantly, to a high recognition accuracy because misplaced endpoints cause poor alignment for template comparison. In some applications many high-level or non-stationary noises may exist in the environment. Noises may come from speakers (lip smacks, mouth clicks), the environments (door slams, fans, machines), or the transmissions (channel noise, cross talk). Variability of durations and amplitudes of different sounds makes reliable speech detection more difficult.

Traditional speech detection methods classify input as speech or non-speech by analyzing a feature space, such as an energy feature space or an acoustic feature space. Speech detection using the energy feature space is useful for clean speech without background noise or crosstalk. The acoustic feature space is useful when phonemes to be uttered by speakers are easily classified. Typically, a feature space is used to classify audio into speech or non-speech, also referred to as speech silence. Segments of speech silence may then be used to delineate speech segments.

### SUMMARY OF THE INVENTION

The exemplary aspects of the present invention enhance robustness for speech detection by fusing observations from multiple feature spaces either in feature space or model space. A speech detection system extracts a plurality of features from multiple input streams. In the acoustic model space, the tree of Gaussians in the model is pruned to include the active states. The Gaussians are mapped to Hidden Markov Model states for Viterbi phoneme alignment. Another feature space, such as the energy feature space is combined with the acoustic feature space. In the feature space, the features are combined and principal component analysis decorrelates the features to fewer dimensions, thus reducing the number of features. The Gaussians are also mapped to silence, disfluent phoneme, or voiced phoneme classes. The silence class is true silence and the voiced phoneme class is speech. The disfluent class may be speech or non-speech. If a frame is classified as disfluent, then that frame is re-classified as the silence class or the voiced phoneme class based on adjacent frame classification.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which exemplary aspects of the present invention may be implemented;

FIG. 2 is a block diagram of a data processing system in which exemplary aspects of the present invention may be implemented;

FIG. 3 is a block diagram depicting a feature based speech detection system using disfluent phone classes and multi-stream observations in accordance with exemplary aspects of the present invention;

FIG. 4A illustrates the audio waveform prior to filtering in accordance with exemplary aspects of the present invention;

FIG. 4B illustrates the corresponding energy tracks in accordance with exemplary aspects of the present invention;

FIG. 5 illustrates a hierarchical acoustic model structure with additional mapping from Gaussians to the speech/silence classes in accordance with exemplary aspects of the present invention;

FIG. 6 is a block diagram depicting training of the fused feature model in accordance with exemplary aspects of the present invention; and

FIG. 7 is a flowchart illustrating operation of a speech detection system in accordance with exemplary embodiments of the present invention.

### DETAILED DESCRIPTION OF THE PREFERRED EMBODIMENT

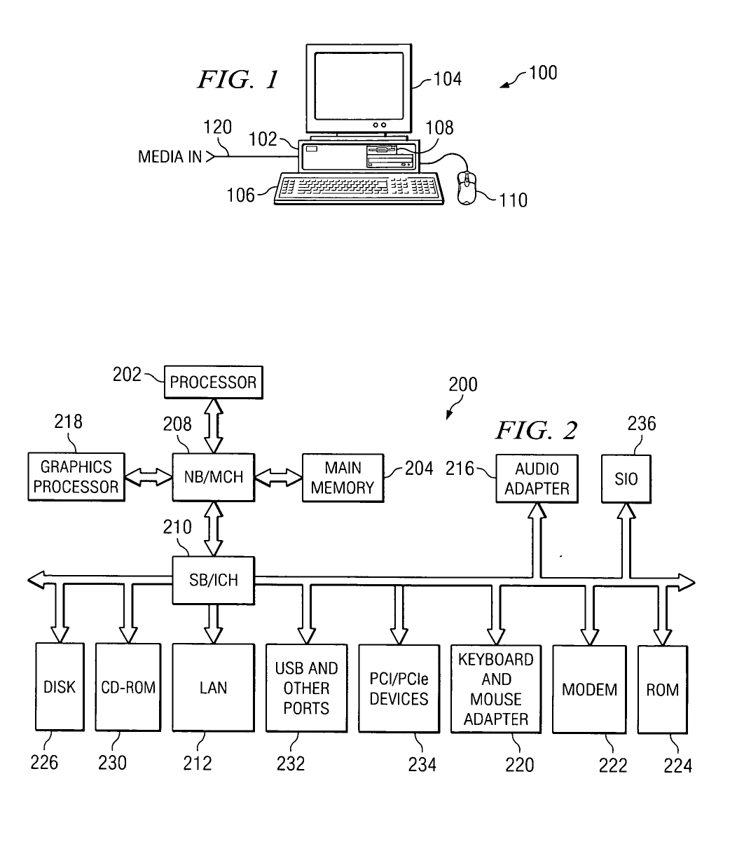

A method, apparatus, and computer program product for providing multi-stream speech detection are provided. The following FIGS. 1 and 2 are provided as exemplary diagrams of data processing environments in which the exemplary aspects of the present invention may be implemented. It should be appreciated that FIGS. 1 and 2 are only exemplary and are not intended to assert or imply any limitation with regard to the environments in which the exemplary aspects of the present invention may be implemented. Many modifications to the depicted environments may be made without departing from the spirit and scope of the exemplary embodiments described herein.

With reference now to the figures and in particular with reference to FIG. 1, a pictorial representation of a data processing system in which exemplary aspects of the present invention may be implemented is depicted. A computer 100 is depicted, which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like.

Computer 100 can be implemented using any suitable computer, such as an IBM eServer™ computer or IntelliStation® computer, which are products of International Business Machines Corporation, located in Armonk, N.Y. Although the depicted representation shows a computer, other embodiments of the present invention may be implemented in other types of data processing systems, such as a network computer or multiple processor data processing system.

Computer 100 may receive media 120 containing speech through, for example, a microphone, a previously recorded audio source, or network transmission. For instance, computer 100 may receive audio through a microphone to be transmitted over a network for audio and/or video conferencing. Alternatively, computer 100 may receive audio with speech to perform speech recognition. In accordance with exemplary aspects of the present invention, computer 100 performs speech detection to classify segments of audio as speech or non-speech. More particularly, computer 100 performs speech detection using multiple streams of features.

With reference now to FIG. 2, a block diagram of a data processing system is shown in which exemplary aspects of the present invention may be implemented. Data processing system 200 is an example of a computer, such as computer 100 in FIG. 1, in which code or instructions implementing the processes of the present invention may be located. In the depicted example, data processing system 200 employs a hub architecture including a north bridge and memory controller hub (MCH) 208 and a south bridge and input/output (I/O) controller hub (ICH) 210. Processor 202, main memory 204, and graphics processor 218 are connected to MCH 208. Graphics processor 218 may be connected to the MCH through an accelerated graphics port (AGP), for example.

In the depicted example, local area network (LAN) adapter 212, audio adapter 216, keyboard and mouse adapter 220, modem 222, read only memory (ROM) 224, hard disk drive (HDD) 226, CD-ROM driver 230, universal serial bus (USB) ports and other communications ports 232, and PCI/PCIe devices 234 may be connected to ICH 210. PCI/PCIe devices may include, for example, Ethernet adapters, add-in cards, PC cards for notebook computers, etc. PCI uses a cardbus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be connected to ICH 210.

An operating system runs on processor 202 and is used to coordinate and provide control of various components within data processing system 200 in FIG. 2. The operating system may be a commercially available operating system such as Windows XP™, which is available from Microsoft Corporation. An object oriented programming system, such as JavaTm programming system, may run in conjunction with the operating system and provides calls to the operating system from Java™ programs or applications executing on data processing system 200. “JAVA” is a trademark of Sun Microsystems, Inc. Instructions for the operating system, the object-oriented programming system, and applications or programs are located on storage devices, such as hard disk drive 226, and may be loaded into main memory 204 for execution by processor 202. The processes of the present invention are performed by processor 202 using computer implemented instructions, which may be located in a memory such as, for example, main memory 204, memory 224, or in one or more peripheral devices 226 and 230.

Those of ordinary skill in the art will appreciate that the hardware in FIG. 2 may vary depending on the implementation. Other internal hardware or peripheral devices, such as flash memory, equivalent non-volatile memory, or optical disk drives and the like, may be used in addition to or in place of the hardware depicted in FIG. 2. Also, the processes of the present invention may be applied to a multiprocessor data processing system.

For example, data processing system 200 may be a personal digital assistant (PDA), which is configured with flash memory to provide non-volatile memory for storing operating system files and/or user-generated data. The depicted example in FIG. 2 and above-described examples are not meant to imply architectural limitations. For example, data processing system 200 also may be a tablet computer, laptop computer, or telephone device in addition to taking the form of a PDA.

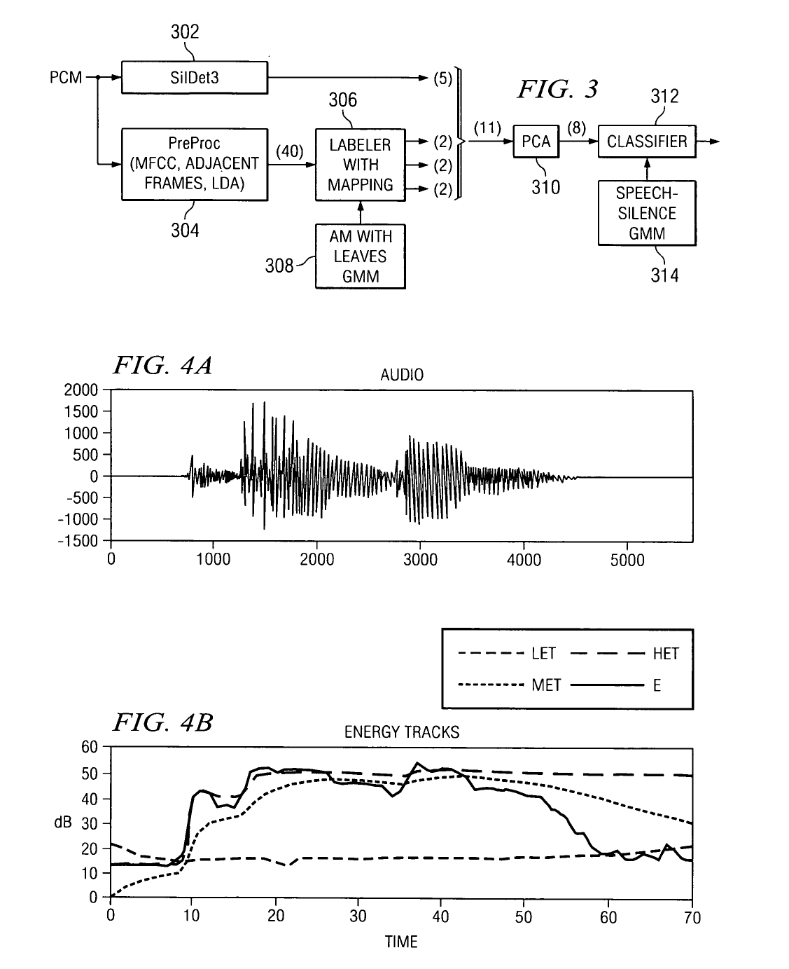

FIG. 3 is a block diagram depicting a feature based speech detection system using disfluent phone classes and multi-stream observations in accordance with exemplary aspects of the present invention. To enhance robustness for speech detection, observations from multiple feature spaces are fused in either feature space or model space. This fusion increases the overall reliability of speech detection over the performance attainable by any one single feature space.

The example system illustrated in FIG. 3 is defined by two feature spaces. At a high level, one feature space, the energy feature space, is generated from waveform energy observations. The other feature space, the acoustic feature space, is generated from acoustic observations. Although not shown in FIG. 3, other feature spaces may be used, such as, for example, facial feature observations from video information.

In the depicted example, media is received as pulse coded modulation (PCM) audio. A person of ordinary skill in the art will realize that other forms of media input may be received. For example, a combination of audio and video may be received. Silence detection module (SilDet3) 302 receives the PCM audio and extracts five features in the illustrated example.

Thus, the energy feature space is generated by a five-dimensional vector based on a high pass filtered waveform. Letting y[i] be the high pass filtered waveform, the feature space is generated by a series of filters applied to the estimated energy, with estimated energy being given by the following equation:

$$e ( t ) = 10 log ( \frac{1}{N} {\sum }_{i = 1}^{N} {y [ i ]}^{2} ) , \qquad Eq . 1$$

where t denotes time. The estimated energy has a resolution limited by the sample rate reflected in the waveform y[i]. The energy may be estimated at a frame rate of 10 msec, for example, with a sliding rectangular window of 10 msec, for example, as defined by the number of samples N. The units of equation 1 are given in dB.

From the estimated energy, e(t), filtered observations are generated from the rms(t) value defined on the linear energy scaled for expected number of bits of resolution. This relationship is shown as follows:
rns(t)=10^{scale*e(t)}. Eq.2
Note that for 16-bit signed linear PCM, the maximum energy would be 90.3 dB. This is used in the scaling of equation 2, with the scale defined as follows:

$$scale = \frac{contrast}{scaleMax} , \qquad Eq . 3$$

with scaleMax=90.3 dB and contrast providing a level of sensitivity, generally in the range of 3.5 to 4.5. Therefore, with the instantaneous rms value, the three tracks, low, mid, and high, may be defined as follows:
lowtrack(t)=(1−aₗ)*lowtrack(t−1)+aₗ*rms(t), Eq.4
midTrack(t)=(1−aₘ)*midtrack(t−1)+aₘ*rms(t), Eq.5
highTrack(t)=(1−aₕ)*highTrack(t−1)+aₕ*rms(t). Eq.6
The time constants for the low and high tracks may be defined by the instantaneous energy of the waveform. With normL and normH given as follows:

$$\begin{matrix}normL = \frac{lowTrack ( t - 1 )}{rms ( t )} , & Eq . 7 \\ normH = \frac{rms ( t )}{highTrack ( t - 1 )} , & Eq . 8\end{matrix}$$

the time constants, aₗ and aₕ are given by the following relationships:
aₗ=(normL)² Eq.9
a_{h=(normH)}² Eq.10
The high and low time constants are proportional and inversely proportional to instantaneous energy in a ratio of the high and low tracks, respectively. This has the effect of high time constant on the low track when the energy is falling and high time constant on the high track when the energy is increasing. The mid track time constant, aₘ, is fixed at 0.1, for example. Therefore, the result is a low pass filtered track of the instantaneous rms(t) energy.

FIG. 4A illustrates the audio waveform prior to filtering in accordance with exemplary aspects of the present invention. This is expressed in Eq. 1 above. FIG. 4B illustrates the corresponding energy tracks in accordance with exemplary aspects of the present invention. The energy tracks shown in FIG. 4B are extracted from the bandpass filtered signal. These tracks are as defined by Eqs. 4-6 above. It may be observed that the low and high energy tracks are intended to lock onto the floor and speech signal levels, respectively, while the mid tack is a lowpass filtered energy track.

A purely energy based speech detector could possibly use a threshold on a mid to low track relationship as follows:
mid2low(t)=mid(t)−low(t), Eq.11
where it is clear that in the presence of speech these two tracks would separate. However, in the exemplary aspects of the present invention, this term is strictly an observation. Therefore, from equations 1, 2, 5, 6, and 11, the five-dimensional energy feature space is as follows:
vₑ(t)=[e(t),low(t),mid(t),high(t),low2mid(t)]. Eq.12

Pre-processing module 304 receives the PCM audio and extracts forty features in the illustrated example. Pre-processing module 304 uses a Mel-frequency cepstral coefficient (MFCC), which is a coefficient used to represent sound. A cepstrum is the result of taking the Fourier transform of the decibel spectrum as if it were a signal. Pre-processing module 304 also uses linear discriminant analysis (LDA), which uses a sliding window to project to a lower subspace. Linear discriminant analysis (LDA), is sometimes referred to as Fisher's linear discriminant, after its inventor, Ronald A. Fisher, who published it in The Use of Multiple Measures in Taxonomic Problems (1936). LDA is typically used as a feature extraction step before classification.

Labeler and mapping module 306 receives the features extracted from pre-processing module 304 and generates observations based on grouping sets of phonemes having broadly defined classes, pure silence phonemes, disfluent phonemes, and voiced phonemes. An example of the disfluent class using the set of ARPAbet phonemes would be {/b/, /d/, /g/, /k/, /p/, /t/, /f/, /s/, /sh}. ARPAbet is a widely used phonetic alphabet that uses only American Standard Code for Information Interchange (ASCII) characters. These observations are based on an acoustic model (AM) with context dependent phonemes known as leaves being modeled by Gausssian Mixure Model (GMM) 308. A Gaussian Mixture Model is a statistical model of speech. The silence phonemes are those trained from non-speech sounds. The disfluent sounds may be defined as the unvoiced fricatives and plosives. All remaining phones are grouped under the class of voiced phones (vowels, voiced fricatives). Therefore, in implementation, speech/silence class posterior probabilities are generated from the acoustic model. These posteriors are used to define another feature space that can be fused in either feature or model space with the energy feature space.

The acoustic model is generated from partitioning the acoustic space by context dependent phonemes with context defined as plus or minus an arbitrary amount from the present phone. The context dependent phonemes are modeled as mixtures of Gaussians. A hidden Markov model (HMM) is a statistical model where the system being modeled is assumed to be a Markov process with unknown parameters, and the challenge is to determine the hidden parameters, from the observable parameters, based on this assumption. In probability theory, a stochastic process has the Markov property if the conditional probability distribution of future states of the process, given the present state, depends only upon the current state, i.e. it is conditionally independent of the past states (the path of the process) given the present state. A process with the Markov property is usually called a Markov process. In general, the defined context dependency can result in an acoustic partitioning of greater than 1000 HMM states, with several hundred Gaussians modeling each state. This will lead to greater than 100,000 Gaussians. Calculating state likelihoods for each state from all Gaussians will preclude a real-time system.

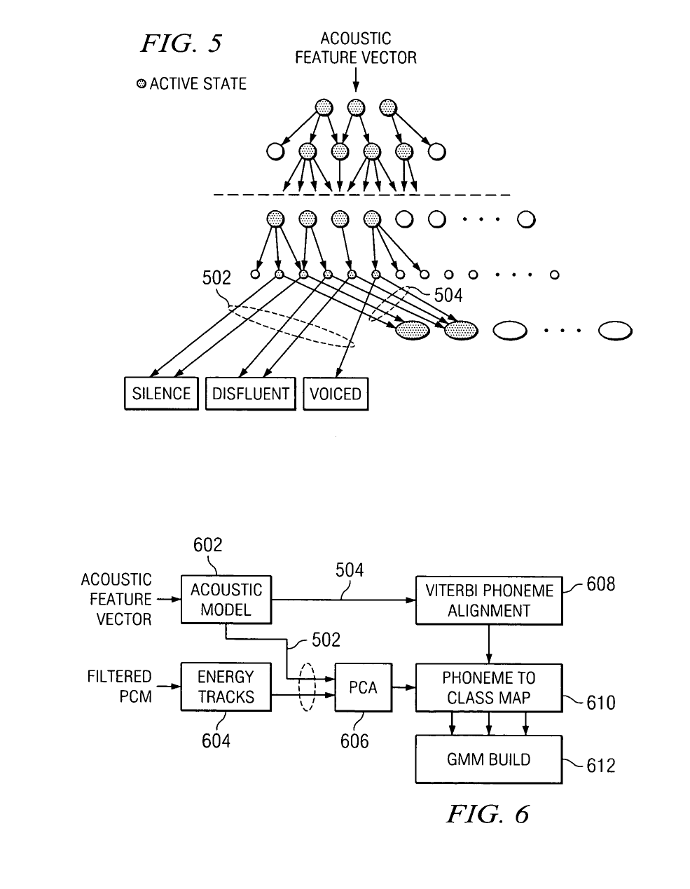

FIG. 5 illustrates a hierarchical acoustic model structure with additional mapping from Gaussians to the speech/silence classes in accordance with exemplary aspects of the present invention. The input is an acoustic feature vector. This may take on many forms as each person implementing the model may believe that a different set of features will provide the best results. The tree results in pruning the number of Gaussians that require evaluation, and, in general, result in sparse evaluation of those Gaussians assigned to active HMM states. The approximation of HMM state likelihoods is given by the following equation:

$$p ( x / S ) = {\sum }_{g ∈ G ( S )} p ( g / S ) p ( x / g ) \approx {max}_{g ∈ y ⋂ G ( S )} p ( g / S ) p ( x / g ) . \qquad Eq . 13$$

Where x is the acoustic feature (LDA or delta features), G(S) is the set of Gaussians defining the state, and Y represents the set of Gaussians that are active after pruning.

Each class in the silence/speech class definition generates two observations. A normalized count of those Gaussians that remain active after hierarchical pruning, N_{S}_{ᵢ}, and a speech or silence likelihood, p(Sᵢ/x), which is given by the following equation:

$$Pr ( {Sp}_{i} \text{\textbar} x ) = \frac{1}{acc\_mass} {\sum }_{g ∈ y ⋂ G ( {Sp}_{i} )} p ( x \text{\textbar} g ) p ( g \text{\textbar} {Sp}_{i} ) , \qquad Eq . 14$$

where

$$acc\_mass = {\sum }_{i = 1}^{3} \{ {\sum }_{g ∈ y ⋂ G ( {Sp}_{i} )} p ( x \text{\textbar} g ) p ( g \text{\textbar} {Sp}_{i} ) \} ,$$

and G(Spᵢ) is the set of Gaussians defined by the mapping from phoneme to speech detection class Spᵢ.

For the three speech/silence class definitions shown in FIG. 5, the speech detection acoustic feature space is given by the following equation:
vₐ(t)=| N̅_{S}_{₁}, p(S₁/x), N̅_{S}_{₂},p(S₂/x), N̅_{S}_{₃},p(S₃/x)]. Eq.15
Using the energy feature space observations and the acoustic feature space observations, a combined speech detection feature space is as follows:
vₛₚ(t)=[vₑ(t),vₐ(t)]. Eq.16
A principal component analysis may then remove the correlation between dimensions of the speech detection feature space. This allows simplification of the underlying Gaussian mixture modeling, where diagonal covariance matrices are assumed. Eq.14 and Eq.15 are related to Gaussian to speech/silence class mappings 502 of FIG. 5. Gaussian to HMM state mappings 504 are used for computation of HMM state probabilities, as described in Eq.13. Gaussian to speech/silence class mappings 502, the Viterbi phoneme alignment, and the combined speech detection feature space shown in Eq.16 are used to train a three-class Gaussian Mixture Model (GMM) classifier, as discussed below with respect to FIG. 6. A hierarchical labeler is used to prune Gaussian densities to be evaluated, as shown in FIG. 5.

Returning to FIG. 3, principal component analysis (PCA) module 310 reduces the combined feature spaces from eleven total features to eight features, in the depicted example. In statistics, principal components analysis (PCA) is a technique that can be used to simplify a dataset; more formally, it is a linear transformation that chooses a new coordinate system for the data set such that the greatest variance by any projection of the data set comes to lie on the first axis (then called the first principal component), the second greatest variance on the second axis, and so on. PCA can be used for reducing dimensionality in a dataset while retaining those characteristics of the dataset that contribute most to its variance by eliminating the later principal components (by a more or less heuristic decision). These characteristics may be the “most important,” but this is not necessarily the case, depending on the application.

The eigenvectors resulting from PCA module 310 define a subspace upon which the GMM classifier is built. Classifier 312 uses speech-silence GMM 314 to classify each frame of eight features, in the depicted example, from PCA module 310 as speech or silence.

Those of ordinary skill in the art will appreciate that the speech detection system shown in FIG. 3 may vary depending on the implementation. Other feature spaces, such as facial features extracted from video media information, may be used in addition to or in place of feature spaces depicted in FIG. 3. Also, other techniques for extracting feature spaces from audio information may be used.

FIG. 6 is a block diagram depicting training of the fused feature model in accordance with exemplary aspects of the present invention. Acoustic model 602 receives an acoustic feature vector as input. Acoustic model 602 provides Gaussian to speech/silence class mappings 502 and Gaussian to HMM state mappings 504 as discussed above with respect to FIG. 5. Energy tracks 604 receives filtered PCM as input and provides an energy feature space, as described by Eq.12 above. Principal component analysis (PCA) module 606 receives the acoustic feature space from mappings 502 and the energy feature space from energy tracks 604 as a combined feature space. PCA module 606 reduces the combined feature spaces from eleven total features to eight features, in the depicted example.

Viterbi phoneme alignment module 608 receives HMM state probabilities that result from mappings 504 and the computation of HMM state probabilities described in Eq.13. Phoneme to class map 610 receives the reduced fused features pace from PCA module 606 and the phoneme alignment from Viterbi phoneme alignment module 608. Phoneme to class map 610 trains three-class Gaussian Mixture Model (GMM) classifier build 612. A Viterbi alignment is used to discover the hidden underlying Markov state sequence. Two deterministic mappings are used to map the HMM state sequence to speech/silence classes. One mapping goes from the HMM state to phoneme level; another mapping, as described above, goes from these phonemes to the desired speech detection classes. With these mappings, one may “bucket” the eight-dimensional speech detection features. This bucketed data is then used to build the underlying speech detection GMMs using an expectation maximization algorithm.

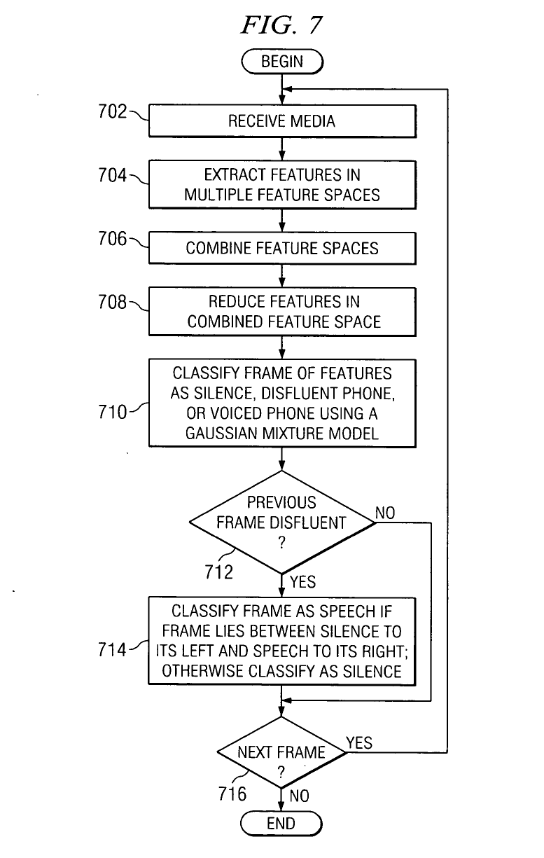

FIG. 7 is a flowchart illustrating operation of a speech detection system in accordance with exemplary embodiments of the present invention. Operation begins and the speech detection system receives input media (block 702). The speech detection system extracts features in multiple feature spaces (block 704) and combines the feature spaces (block 706). Thereafter, the speech detection system uses principal component analysis to reduce the features in the combined feature space (block 708). Then, the speech detection system classifies the current frame of features as silence, disfluent, or speech using a Gaussian Mixture Model (block 710).

Next, a determination is made as to whether the previous frame is disfluent (block 712). If the previous frame is disfluent, then it is re-classified as speech if the frame lies between silence to its left and speech to its right; otherwise, the previous frame is classified as silence (block 714). Thereafter, a determination is made as to whether a next frame is to be classified (block 716). If the previous frame is not disfluent in block 712, operation proceeds directly to block 716 to determine whether a next frame is to be classified. If a next frame is to be classified, operation returns to block 702 to receive the input media. If, however, a next frame is not to be classified in block 716, operation ends.

Thus, the exemplary aspects of the present invention solve the disadvantages of the prior art by providing speech detection using multiple input streams, multiple feature spaces, and multiple partitions of the acoustic space. A speech detection system extracts a plurality of features from multiple input streams. In the feature space, the features are combined and principal component analysis decorrelates the features to fewer dimensions, thus reducing the number of features. In the model space, the tree of Gaussians in the model is pruned and the Gaussians are mapped to speech/silence classes. Principal component analysis is used to reduce the dimensions of the feature space and a classifier classifies each frame of features as speech or non-speech.

It is important to note that while the exemplary aspects of the present invention have been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the exemplary aspects of the present invention has been presented for purposes of illustration and description and is not intended to be exhaustive or limited to the invention in the form disclosed. Many modifications and variations will be apparent to those of ordinary skill in the art. The exemplary embodiments were chosen and described in order to best explain the principles of the invention, the practical application, and to enable others of ordinary skill in the art to understand the invention for various embodiments with various modifications as are suited to the particular use contemplated.

What is claimed is:

1. A computer implemented method for speech detection, the computer implemented method comprising:
receiving media input;
generating a current frame of features from the media input;
classifying the current frame of features as a class selected from a set including at least a silence class, a disfluent class, and a speech class;
re-classifying the current frame as the speech class if the current frame is classified as the disfluent class and lies between a previous frame classified as the silence class and a next frame classified as the speech class; and
re-classifying the current frame as the silence class if the current frame is classified as the disfluent class and does not lie between a previous frame classified as the silence class and a next frame classified as the speech class.

2. The computer implemented method of claim 1, wherein generating a current frame of features from the media input comprises:
extracting a first frame of features from the media input in a first feature space;
extracting a second frame of features from the media input in a second feature space;
combining at least the first frame of features and the second frame of features to form a combined frame of features;
reducing the number of features in the combined frame of features to form the current frame of features.

3. The computer implemented method of claim 2, wherein the first feature space is an energy feature space.

4. The computer implemented method of claim 2, wherein the second feature space is an acoustic feature space.

5. The computer implemented method of claim 2, wherein reducing the number of features in the combined frame of features comprises performing linear discriminant analysis on the combined frame of features.

6. The computer implemented method of claim 1, wherein classifying the current frame of features comprises classifying the current frame using a Gaussian Mixture Model.

7. The computer implemented method of claim 1, wherein the media input is pulse coded modulated audio.

8. A computer program product comprising:
a computer usable medium having computer usable program code for speech detection, the computer usable program code comprising:
computer usable program code for receiving media input;
computer usable program code for generating a current frame of features from the media input;
computer usable program code for classifying the current frame of features as a class selected from a set including at least a silence class, a disfluent class, and a speech class; and
computer usable program code for re-classifying the current frame as the speech class if the current frame is classified as the disfluent class and lies between a previous frame classified as the silence class and a next frame classified as the speech class; and
computer usable program code for re-classifying the current frame as the silence class if the current frame is classified as the disfluent class and does not lie between a previous frame classified as the silence class and a next frame classified as the speech class.

9. The computer program product of claim 8, wherein the computer usable program code for generating a current frame of features from the media input comprises:
computer usable program code for extracting a first frame of features from the media input in a first feature space;
computer usable program code for extracting a second frame of features from the media input in a second feature space;
computer usable program code for combining at least the first frame of features and the second frame of features to form a combined frame of features;
computer usable program code for reducing the number of features in the combined frame of features to form the current frame of features.

10. The computer program product of claim 9, wherein the first feature space is an energy feature space.

11. The computer program product of claim 9, wherein the second feature space is an acoustic feature space.

12. The computer program product of claim 9, wherein the computer usable program code for reducing the number of features in the combined frame of features comprises computer usable program code for performing linear discriminant analysis on the combined frame of features.

13. The computer program product of claim 8, wherein the computer usable program code for classifying the current frame of features comprises computer usable program code for classifying the current frame using a Gaussian Mixture Model.

14. The computer program product of claim 8, wherein the media input is pulse coded modulated audio.

15. A data processing system for speech detection, the data processing system comprising:
a memory having stored therein computer program code; and
a processor coupled to the memory, wherein the processor operates under control of the computer program code to receive media input; generate a current frame of features from the media input; classify the current frame of features as a class selected from a set including at least a silence class, a disfluent class, and a speech class; re-classify the current frame as the speech class if the current frame is classified as the disfluent class and lies between a previous frame classified as the silence class and a next frame classified as the speech class; and re-classify the current frame as the silence class if the current frame is classified as the disfluent class and does not lie between a previous frame classified as the silence class and a next frame classified as the speech class.

16. The data processing system of claim 15, wherein the processor operates under control of the computer program code to generate a current frame of features from the media input by extracting a first frame of features from the media input in a first feature space, extracting a second frame of features from the media input in a second feature space, combining at least the first frame of features and the second frame of features to form a combined frame of features, and reducing the number of features in the combined frame of features to form the current frame of features.

17. The data processing system of claim 16, wherein the first feature space is an energy feature space.

18. The data processing system of claim 16, wherein the second feature space is an acoustic feature space.

19. The data processing system of claim 16, wherein the processor operates under control of the computer program code to reduce the number of features in the combined frame of features by performing linear discriminant analysis on the combined frame of features.

20. The data processing system of claim 15, wherein.the processor operates under control of the computer program code to classify the current frame of features using a Gaussian Mixture Model.
